(19) United States
(12) Patent Application Publication
(10) Pub. No.: US 2025/0328617 A1
(43) Pub. Date: Oct. 23, 2025

(54) INFORMATION PROCESSING DEVICE, INFORMATION PROCESSING METHOD, AND PROGRAM

(71) Applicant: Sony Group Corporation, Tokyo (JP)

(72) Inventors: Takashi OGATA, Tokyo (JP); Ayaka NISHI, Kanagawa (JP); Atsushi NEGISHI, Tokyo (JP)

(73) Assignee: Sony Group Corporation, Tokyo (JP)

(21) Appl. No.: 18/861,881

(22) PCT Filed: Apr. 11, 2023
(86) PCT No.: PCT/JP2023/014729

§ 371 Date: Oct. 31, 2024

(30) Foreign Application Priority Data
May 31, 2022 (JP) 2022-088859

(51) Int. Cl. G06F 21/31; G06Q 20/40

(52) U.S. Cl. CPC G06F 21/316; G06Q 20/4016

(57) ABSTRACT

There are provided an information processing device, an information processing method, and a program that can reduce disadvantages of a user during use of authentication based on a user's activity. The information processing device includes a control unit that performs: processing of calculating a target authentication score based on a habitual score calculated based on an activity of a user and habitual information of the user, and a use occasion score calculated based on a target use history of the user; and processing of determining based on the target authentication score whether authentication at a target succeeds or fails.

### TECHNICAL FIELD

The present disclosure relates to an information processing device, an information processing method, and a program.

### BACKGROUND ART

As one of authentications (also referred to as identity verification) for confirming that a user is identified, biometric authentication such as fingerprint authentication or face recognition that uses physical features is used. Furthermore, in recent years, behavioral biometric authentication of identifying a user from a walking form and an activity has been developed. As described above, there are currently multiple authentication methods. For example, following PTL 1 discloses selecting a method matching a security level necessary for authentication among a plurality of authentication methods.

### CITATION LIST

### Patent Literature

PTL 1: JP 2019-219999 A

### SUMMARY

### Technical Problem

However, since, when behavioral biometric authentication is used, a certain learning period is required until sufficient authentication accuracy is achieved, an activity greatly changes from an everyday lifestyle due to moving, job change, business trip, or travel, it is concerned that this behavioral biometric authentication cannot be used or an operation is performed with sufficient recognition accuracy.

Therefore, the present disclosure proposes an information processing device, an information processing method, and a program that can reduce disadvantages of a user during use of authentication based on a user's activity.

### Solution to Problem

The present disclosure provides an information processing device that includes a control unit that performs: processing of calculating a target authentication score based on a habitual score calculated based on an activity of a user and habitual information of the user, and a use occasion score calculated based on a target use history of the user; and processing of determining based on the target authentication score whether authentication at a target succeeds or fails.

Furthermore, the present disclosure provides an information processing method comprising at a processor: calculating a target authentication score based on a habitual score calculated based on an activity of a user and habitual information of the user, and a use occasion score calculated based on a target use history of the user; and determining based on the target authentication score whether authentication at a target succeeds or fails.

Furthermore, the present disclosure provides a program that causes a computer to function as a control unit that performs: processing of calculating a target authentication score based on a habitual score calculated based on an activity of a user and habitual information of the user, and a use occasion score calculated based on a target use history of the user; and processing of determining based on the target authentication score whether authentication at a target succeeds or fails.

### BRIEF DESCRIPTION OF DRAWINGS

FIG. 1 is a block diagram illustrating an example of a configuration of an information processing device according to the present embodiment.

FIG. 2 is a block diagram for explaining a functional configuration of a model generation unit according to the present embodiment.

FIG. 3 is a block diagram for explaining a functional configuration of a score calculation unit according to the present embodiment.

FIG. 4 is a diagram illustrating an example of shop layers according to the present embodiment.

FIG. 5 is a diagram illustrating a calculation example of a use frequency of a layer 1 according to the present embodiment.

FIG. 6 is a diagram illustrating a calculation example of a use frequency of a layer 2 according to the present embodiment.

FIG. 7 is a diagram illustrating a calculation example of a use frequency of a layer 3 according to the present embodiment.

FIG. 8 is a diagram illustrating an example of a use frequency matching a time zone and a day of a week in a case of the layer 3 according to the present embodiment.

FIG. 9 is a flowchart illustrating an example of a flow of authentication score calculation processing according to the present embodiment.

FIG. 10 is a flowchart illustrating an example of a flow of payment processing according to the present embodiment.

FIG. 11 is a flowchart illustrating an example of a flow of authentication success/failure decision display processing according to the present embodiment.

FIG. 12 is a diagram illustrating an example of a display screen showing an authentication success/failure determination result according to the present embodiment.

FIG. 13 is a diagram for explaining an example of weight adjustment according to the present embodiment.

FIG. 14 is a diagram illustrating an example of the display screen showing an authentication determination result based on the authentication score corrected by weight adjustment according to the present embodiment.

FIG. 15 is a diagram for explaining adjustment of an authentication threshold according to the present embodiment.

FIG. 16 is a diagram illustrating an example of an adjustment screen of the authentication threshold according to the present embodiment.

FIG. 17 is a diagram illustrating an example of the display screen updated by adjusting the authentication threshold according to the present embodiment.

FIG. 18 is a diagram for explaining weight adjustment of the shop layer according to the present embodiment.

FIG. 19 is a diagram illustrating an example of a weight adjustment screen of the shop layer according to the present embodiment.

FIG. 20 is a diagram illustrating an example of the display screen updated by weight adjustment of the shop layer according to the present embodiment.

### DESCRIPTION OF EMBODIMENTS

A preferred embodiment of the present disclosure will be described in detail with reference to the accompanying figures below. Also, in the present specification and the figures, components having substantially the same functional configuration will be denoted by the same reference numerals, and thus repeated descriptions thereof will be omitted.

Furthermore, the description is assumed to be given in the following order.
1. Overview of Authentication System According to One Embodiment of Present Disclosure
2. Configuration Example of Information Processing Device 10
3. Operation Processing
3-1. Authentication Score Calculation Processing
3-2. Payment Processing
3-3. Display Processing
4. Supplements

### <<1. Overview of Authentication System According to One Embodiment of Present Disclosure>>

An authentication system according to the present embodiment relates to not physical biometric authentication that needs an active operation of the user like fingerprint authentication or face recognition, but behavioral biometric authentication for sensing an everyday activity of a user and determining an identity of the user from activity features of the user as biometric authentication for confirming whether or not the user who uses a service is identified. As the activity features, for example, a habit of a walking form, moving means, a habit of a movement trajectory (activity range), and the like are used. For example, a device possessed by a user continues determining a user identity by behavioral biometric authentication, so that it is possible to authenticate the user without requiring a user's active operation.

### (Summary of Problem)

However, since, when behavioral biometric authentication is used, a certain learning period is required until sufficient authentication accuracy is achieved, an activity greatly changes from an everyday lifestyle due to moving, job change, business trip, or travel, it is concerned that this behavioral biometric authentication cannot be used or an operation is performed with sufficient recognition accuracy.

Therefore, the present disclosure proposes an authentication system that can reduce disadvantages of a user during use of authentication based on a user's activity.

More specifically, although authentication accuracy of behavioral biometric authentication lowers when an activity greatly changes, the authentication system according to the present embodiment can enhance user-friendliness while keeping authentication accuracy by securing an identity at a target whose required authentication level is low (that is, a threat risk is low) in such a case.

A target of a low threat risk can be decided based on a target use history of a user. For example, a mode that uses behavioral biometric authentication for payment at a shop is assumed. The user's activity can be continuously sensed by a device (an information device that is more specifically a mobile terminal such as a smartphone or a smartwatch) possessed by the user. When authentication based on a user's activity history succeeds in the device carried by the user, payment can be executed by operating the device at the store. For example, wireless communication is performed between the device and a settlement device of the store, and electronic payment that is payment using electronic money or a registered credit card can be performed. Note that payment that does not require an operation of the device is assumed as hands-free payment that enables payment without taking out the device from a bag or a pocket, or touch payment performed by holding the device over a reading unit connected to the settlement device.

Here, a threat risk of identity theft by other people or the like is low in a case of a shop habitually and frequently used by the user or an affiliated shop of the shop frequently used by the user, and, even when a behavioral biometric authentication score is low, user-friendliness may be enhanced by securing the identity. The authentication system according to the present embodiment enables success of authentication as appropriate even when a score based on an activity history lowers by calculating an integral score per use target (e.g., shop) and performing authentication based on a score (referred to as a habitual score in the present embodiment) indicating an identity calculated based on the activity history, and a score (referred to as a use occasion score in the present embodiment) indicating an identify calculated based on a use history.

Note that examples of a use target shop include convenience stores, supermarkets, department stores, shops, restaurants, and the like. Furthermore, use of a shop more specifically means payment at the shop. Furthermore, the use target is not limited to shops (more specifically, payment at the shops), and are assumed as various places such as public transports (such as railways, buses, and taxis), hospitals, pharmacies, post offices, and accommodations. Furthermore, although an example of authentication required for “payment” will be described as an example of authentication of a target, the present embodiment is not limited thereto, and for example, authentication required to inspect tickets at use targets (so-called spots), permit whether or not to share information (for example, share patient information), log in systems, and unlock doors.

The overview of the authentication system according to the embodiment of the present disclosure has been described above. Next, a configuration example of a device for implementing the authentication system according to the present embodiment will be described with reference to the drawings.

### 2. Configuration Example of Information Processing Device 10

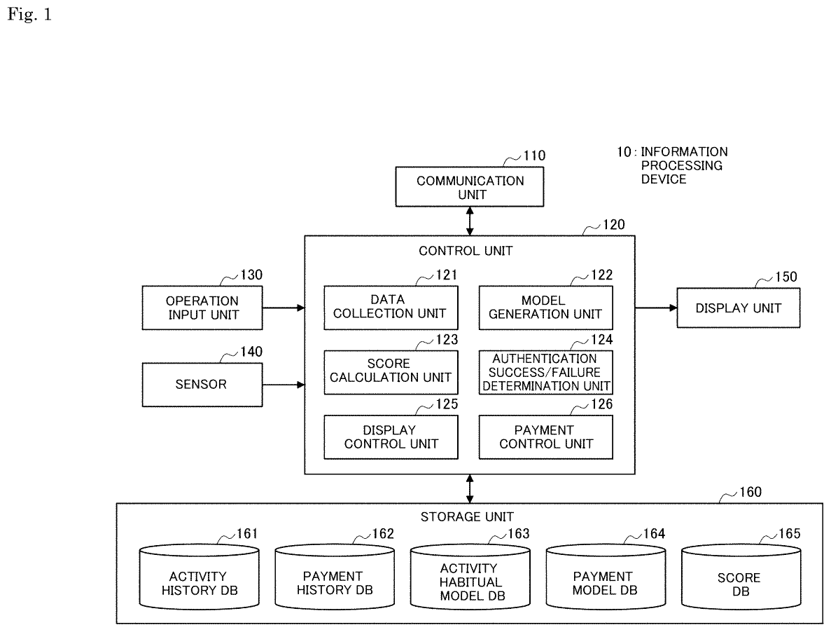

FIG. 1 is a block diagram illustrating a configuration example of the information processing device 10 according to the present embodiment. The information processing device 10 is a device that performs authentication (also referred to as identity verification) of confirming whether or not a user of the information processing device is identified as an owner based on an activity history and a use history of the user. The information processing device 10 is implemented as, for example, a mobile terminal such as a smartphone or a smartwatch.

As illustrated in FIG. 1, the information processing device 10 includes a communication unit 110, a control unit 120, an operation input unit 130, a sensor 140, a display unit 150, and a storage unit 160.

### (Communication Unit 110)

The communication unit 110 includes a transmission unit that transmits data to an external device, and a reception unit that receives data from the external device. The communication unit 110 communicates with or is connected to the external device or the Internet via, for example, a wired/wireless Local Area Network (LAN), Wi-Fi (registered trademark), Bluetooth (registered trademark), or a mobile communication network (Long Term Evolution (LTE), the fourth-generation mobile communication system (4G), and the fifth-generation mobile communication system (5G)), and the like.

For example, the communication unit 110 according to the present embodiment wirelessly communicates with and is connected with a settlement device at a shop, and transmits and receives data for electronic payment processing. Furthermore, the communication unit 110 may transmit an authentication result to a payment terminal (e.g., a smartwatch or a smart band) equipped by the user.

### (Operation Input Unit 130 and Display Unit 150)

The operation input unit 130 accepts an operation input of the user, and outputs input information to the control unit 120. Furthermore, the display unit 150 displays various operation screens, and a display screen that displays an authentication success/failure determination result of each shop to be described later. The display unit 150 may be a display panel such as a Liquid Crystal Display (LCD) or an organic Electro Luminescence (EL). The operation input unit 130 and the display unit 150 may be integrally provided. For example, the operation input unit 130 may be a touch sensor that is stacked on the display unit 150 (e.g., panel display).

### (Sensor 140)

The sensor 140 includes various sensors that sense a user's activity. Examples of the various sensors include a gyro sensor, an acceleration sensor, a geomagnetic sensor, a position measurement unit, a distance sensor, a camera, and the like. The position measurement unit may be a measurement unit that measures an absolute position (e.g., a component that measures a position using a Global Navigation Satellite System (GNSS)), and may be a measurement unit that measures a relative position (e.g., a component that measures a position using a signal of Wi-Fi or Bluetooth).

### (Control Unit 120)

The control unit 120 functions as an arithmetic operation processing device and a control device, and controls overall operations in the information processing device 10 according to various programs. The control unit 120 is implemented as, for example, an electronic circuit such as a Central Processing Unit (CPU) or a microprocessor. Furthermore, the control unit 120 may include a Read Only Memory (ROM) that stores programs, arithmetic operation parameters, or the like to be used, and a Random Access Memory (RAM) that temporarily stores appropriately changing parameters, or the like.

Furthermore, the control unit 120 also functions as a data collection unit 121, a model generation unit 122, a score calculation unit 123, an authentication success/failure determination unit 124, a display control unit 125, and a payment control unit 126.

The data collection unit 121 collects various items of data (an activity history and a payment history) for performing authentication, and stores the various items of data in each of an activity history DB 161 and a payment history DB 162. For example, the data collection unit 121 collects various items of sensing data acquired by the sensor 140, and stores the various items of sensing data as the activity history in the activity history DB 161. Furthermore, the data collection unit 121 may collect information on a network situation acquired by the communication unit 110, and store the information as the activity history in the activity history DB 161. Examples of the information on the network situation include monitoring data of wireless communication such as Wi-Fi or Bluetooth (BT). More specifically, the information is, for example, information on the intensity of each radio wave, a channel, and an access point. Furthermore, the data collection unit 121 stores a result of payment performed by the payment control unit 126 as the payment history (an example of a use history) in the payment history DB 162.

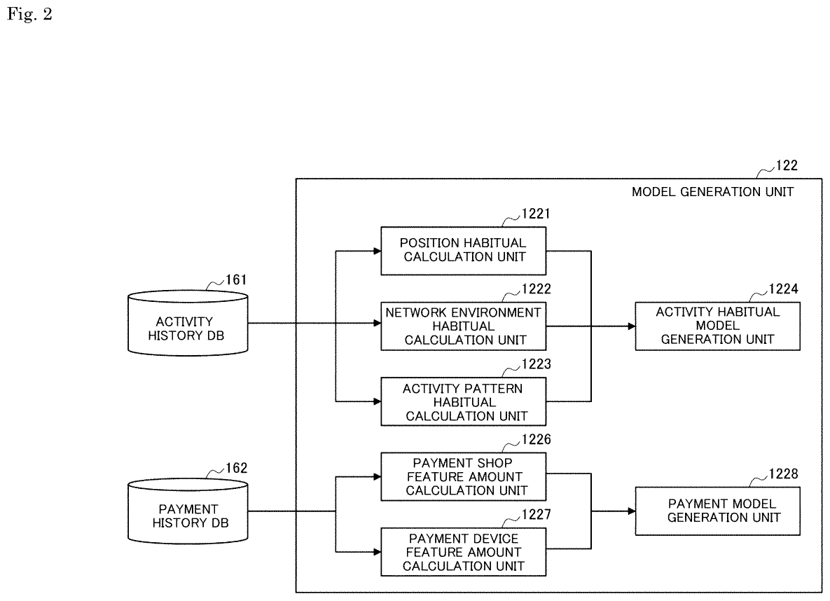

The model generation unit 122 generates a model used at a time of calculation of a score for authentication. More specifically, the model generation unit 122 generates an activity habitual model based on the activity history, and stores the activity habitual model in an activity habitual model DB 163. Furthermore, the model generation unit 122 generates a payment model based on the payment history, and stores the payment model in a payment model DB 164. Each model may be regularly updated. Hereinafter, the model generation unit 122 will be more specifically described with reference to FIG. 2.

FIG. 2 is a block diagram for explaining a functional configuration of the model generation unit 122 according to the present embodiment. As illustrated in FIG. 2, based on the activity history of the user (e.g., position information, network environment information, motion information, and the like) accumulated in the activity history DB 161, the model generation unit 122 causes a position habitual calculation unit 1221 to calculate habitualness of a position, causes a network environment habitual calculation unit 1222 to calculate habitualness of a network environment, and causes an activity pattern habitual calculation unit 1223 to calculate habitualness of an activity pattern. Note that these habitualness calculated based on the activity history are examples, and the present embodiment is not limited thereto. As for the position, the network environment, the activity pattern, and the like, a user identity is calculated as feature amounts. Furthermore, an activity habitual model generation unit 1224 integrates each calculated habitualness (position habitualness, network environment information habitualness, and activity pattern habitualness), and generates an activity habitual model. Consequently, the score calculation unit 123 to be described can recognize a habitual activity of the user. For each calculation and model generation, machine learning may be used.

Furthermore, based on the payment history (such as a payment shop, a payment device, and a payment date) of the user accumulated in the payment history DB 162, the model generation unit 122 causes a payment shop feature amount calculation unit 1226 to calculate a feature amount of the payment shop (a shop at which payment has been performed), and causes a payment device feature amount calculation unit 1227 to calculate a feature amount of the payment device (a device used for payment). Furthermore, a payment model generation unit 1228 integrates the calculated feature amounts (a payment shop feature amount and a payment device feature amount), and generates a payment model. Consequently, the score calculation unit 123 to be described can recognize a shop and an affiliated shop habitually and frequently used by the user, and a device habitually and frequently used by the user. For each calculation and model generation, machine learning may be used.

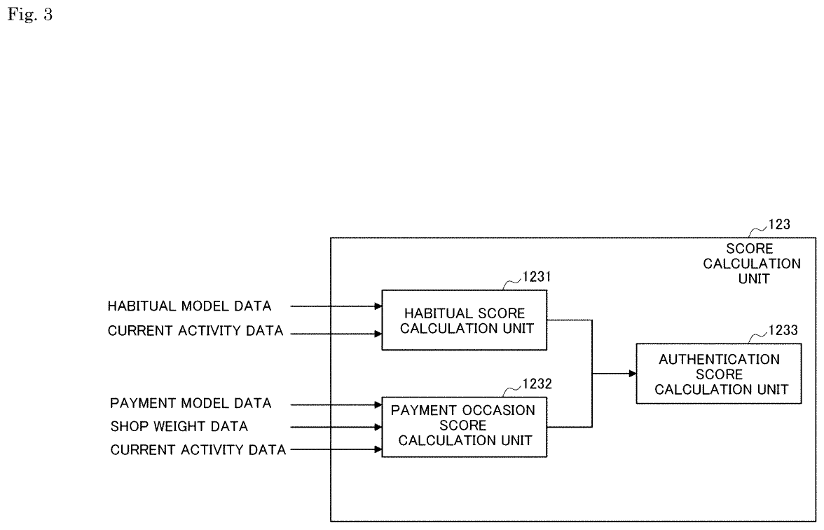

The score calculation unit 123 calculates a score for authentication. More specifically, the score calculation unit 123 calculates a target authentication score based on a habitual score calculated based on a current activity of the user and habitual information of the user (the activity habitual model generated based on the activity history), and a use occasion score calculated based on a target use history of the user. The target use history described here is more specifically a payment history at each shop. Furthermore, the target authentication score described here is more specifically an authentication score used for authentication at a time of payment at a shop. Furthermore, the use occasion score is a value indicating an identity at a use target calculated based on the use history, and is calculated higher for a use target that matches with a use tendency of the user. In the present embodiment, for example, a payment occasion score is calculated based on the payment history of the user. Note that the use occasion score is not limited to the payment occasion score, and may be also assumed as an inspection occasion score based on a ticket inspection history at various facilities such as a public transport, and a share occasion score based on a share history of various pieces of information such as patient information. Hereinafter, the score calculation unit 123 will be more specifically described with reference to FIG. 3.

FIG. 3 is a block diagram for explaining a functional configuration of the score calculation unit 123 according to the present embodiment. As illustrated in FIG. 3, the score calculation unit 123 causes a habitual score calculation unit 1231 to calculate a habitual score based on current activity data of the user (e.g., activity data during a certain period up to a current time) and the activity habitual model. Furthermore, the score calculation unit 123 causes a payment occasion score calculation unit 1232 to calculate a payment occasion score (an example of a use occasion score) based on the payment model, shop weight data, and current activity data (that is more specifically position information and for which time data may be used). Details of calculation of each score will be described later. Furthermore, an authentication score calculation unit 1233 calculates an authentication score based on the habitual score and the payment occasion score. Hereinafter, calculation of each score will be described in detail.

### Calculation of Habitual Score

The habitual score is a value that is calculated as a higher value when habitual information (more specifically, activity habitual model) learned from a past activity history of the user and a current activity are compared and the current activity is close to the habitual activity of the user. The habitual score is also a value indicating an identity based on activity features.

The habitual score calculation unit 1231 may calculate a habitual score (Score_{habit}) by adding a habitual space score (Score_{space}), a habitual activity score (Score_{activity}), and a habitual use device score (Score_{device}) as expressed in, for example, the following equation. Note that, as expressed in the following equation, for example, each of the habitual space score, the habitual activity score, and the habitual use device score may be multiplied with a weight (W).

$${Score}_{h a b i t} = {W}_{space} * {Score}_{space} + {W}_{acti v i t y} * {Score}_{a c t i v i t y} + {W}_{devi c e} * {Score}_{d e v i c e} \qquad [ Math . 1 ]$$

The habitual space score is a score indicating to what degree the user is located in a habitual activity range of the user within the certain period up to the current time. The habitual activity range of the user can be acquired from the activity habitual model generated from the activity history of the user. The habitual score calculation unit 1231 determines that the identity is higher as a time during which the user is located in the habitual activity range of the user is longer, and calculates a higher value based on the position information on the user during the certain period up to the current time. Furthermore, the habitual activity score is a score indicating to what degree a motion of the user during the certain period up to the current time is close to a habitual motion of the user. The habitual motion of the user may be acquired from the activity habitual model generated from the activity history of the user. Examples of the habitual motion of the user include features of a walking form or a running form, the running form, a boarding situation (a situation indicating in what vehicle and how long the user is in), and the like. The habitual score calculation unit 1231 determines that the identity is higher as the motion of the user is closer to the habitual motion of the user, and calculates a higher value. Furthermore, the habitual use device score is a score indicating whether or not a device possessed or used by the user is a device frequently possessed or used by the user during the certain period up to the current time. The habitual score calculation unit 1231 determines that the identity is high, and calculates a high value when the device is the device frequently possessed or used by the user. The habitual score calculation unit 1231 may determine that the device is “frequently possessed or used” when a predetermined time or the number of times of use is a predetermined value or more.

The habitual score calculation unit 1231 may perform weighting as appropriate as expressed in the above equation when adding the habitual space score (Score_{space}), the habitual activity score (Score_{activity}), and the habitual use device score (Score_{device}). Note that each score to be added is an example, and the present embodiment is not limited thereto.

The habitual score calculation unit 1231 continuously calculates the habitual score while the user lives an everyday life. By accumulating the activity history, it is possible to perform more accurate authentication. On the other hand, when an activity greatly changes from the habitual activity in the beginning of an accumulation period or at a time of moving, job change, travel, or the like, it is considered that the authentication score lowers. In the present embodiment, by calculating an integral authentication score used for authentication by further using a payment occasion score (an example of a use occasion score) to be described next, it is possible to secure the identity even in a situation that the habitual score (the authentication score based on the activity feature) lowers.

### Calculation of Payment Occasion Score

The payment occasion score calculation unit 1232 calculates a payment occasion score at each shop from the payment history of the user. The payment occasion score is a value indicating an identity at a time of use at a shop, and calculates a higher value for a shop that matches with features of payment (above-described payment model) based on the payment history of the user. More specifically, the payment occasion score calculation unit 1232 may calculate the payment occasion score based on the payment model (including a payment shop feature amount and a payment device feature amount) generated from the payment history of the user, shop weight data, and activity data of the user. The activity data is, for example, current position information. Furthermore, the activity data may further include time data (current time).

More specifically, the payment occasion score calculation unit 1232 may calculate a payment occasion score (Score_{payment}) by adding a payment shop score (Score_{pay_shop}) and a payment device score (Score_{pay_device}) as expressed in, for example, the following equation. The payment shop score is an example of a target score. Furthermore, each score may be multiplied with the weight (W) as appropriate. Furthermore, the payment occasion score calculation unit 1232 may calculate the payment occasion score for a shop located near the user (e.g., within a certain range from the position of the user) as appropriate by using position data of the user.

$${Score}_{p a y m e n t} = {W}_{pay \_ shop} * {Score}_{pay \_ shop} + {W}_{pay \_ device} * {Score}_{pay \_ device} \qquad [ Math . 2 ]$$

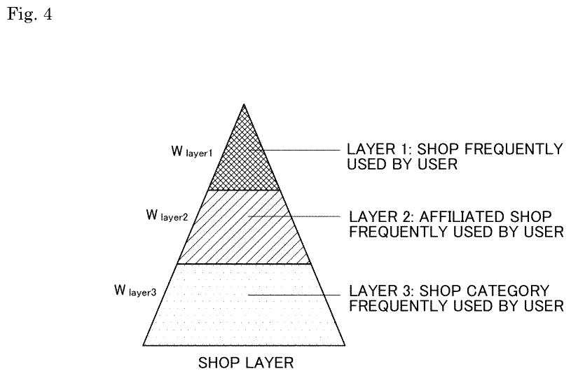

The payment occasion score calculation unit 1232 calculates a higher score as a payment shop score (Score_{pay_shop}) of a target shop as a shop is more frequently by the user. The frequently used shop means, for example, a shop whose use rate is higher than those of other shops among shops used by the user. Note that a shop is not limited to a shop actually used (paid) by the user, and, taking into account authentication in an area that the user has never visited before, too, a score may be given from a viewpoint of an affiliated shop (also referred to as a frequently used affiliated shop) whose use rate of the user is high, and a shop category (also referred to as a frequently used shop category) whose use rate of the user is high. More specifically, the payment occasion score calculation unit 1232 may use a weight set per shop layer (an example of a target layer) as illustrated in, for example, FIG. 4 to calculate the payment occasion score. FIG. 4 is a diagram illustrating an example of shop layers according to the present embodiment. As illustrated in FIG. 4, for example, a layer 1: a shop habitually used by the user, a layer 2: an affiliated shop habitually used, and a layer 3: a shop category habitually used are defined as shop layers. Weights (W_{layer1}, W_{layer2}, and W_{layer3}) of each shop layer are acquired from shop weight data.

Next, calculation of a use frequency of each layer will be described. The payment occasion score calculation unit 1232 calculates a use frequency of each shop, a use frequency of each affiliated shop, and a use frequency of each shop category. The payment occasion score calculation unit 1232 may calculate various use frequencies using the above payment model (including the payment shop feature amount).

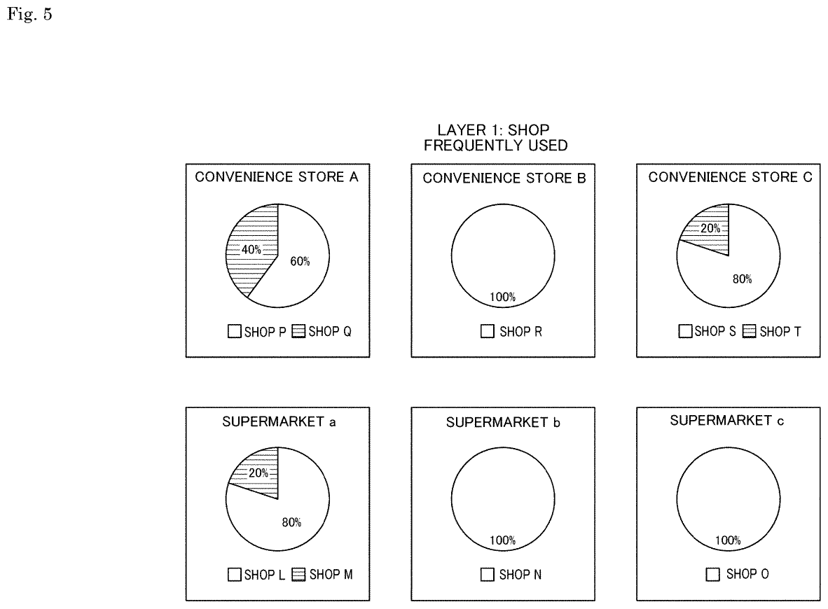

FIG. 5 is a diagram illustrating a calculation example of a use frequency of the layer 1 according to the present embodiment. In the layer 1, for example, the use frequency is calculated for a shop actually used (paid) by the user per affiliated shop (company). More specifically, as for a shop P and a shop Q of a convenience store A, 60% is calculated as the use frequency and 40% is calculated as the use frequency of the shop Q according to a rate of the number of times of use (payment). Furthermore, when only a shop R affiliated with a convenience store B is used, 100% is calculated for the shop R. Furthermore, the target shop is not limited to a convenience store (hereinafter, also referred to as a CVS), and widely include shops such as supermarkets and other stores at which a predetermined service (payment in this case) that requires authentication is performed. Note that, although the case has been described as the example where the use frequency is calculated per affiliated shop (company), the present invention is not limited thereto, and, for example, the use frequency of each shop may be calculated per category. For example, the use frequency is calculated as 40% for the shop P of the CVS A, as 20% for the shop R, as 30% for the shop Q of the CVS B, and as 10% for a shop S.

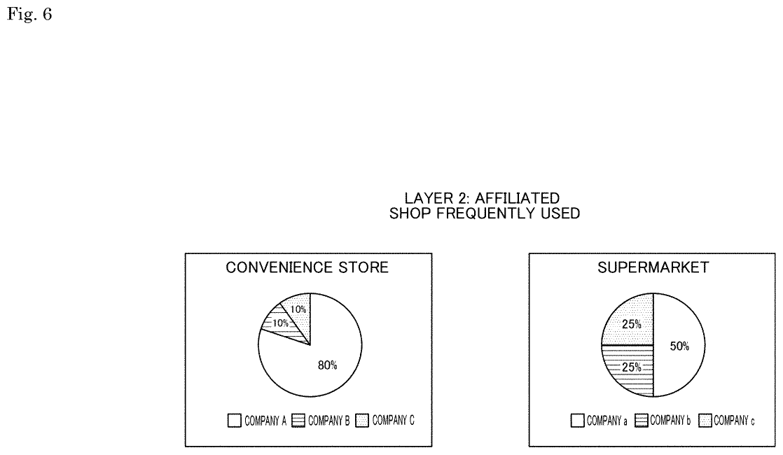

FIG. 6 is a diagram illustrating a calculation example of a use frequency of the layer 2 according to the present embodiment. In the layer 2, for example, the use frequency is calculated for business affiliation (company) of a shop actually used by the user. As illustrated in, for example, FIG. 6, 80% is calculated for the CVS A, 10% is calculated for the CVS B, and 10% is calculated for a CVS C.

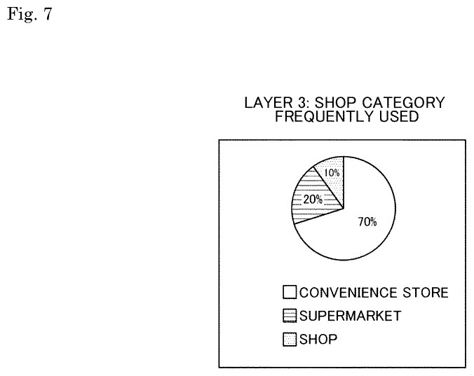

FIG. 7 is a diagram illustrating a calculation example of a use frequency of the layer 3 according to the present embodiment. In the layer 3, for example, the use frequency is calculated for a category (business category) of a shop actually used by the user. As illustrated in, for example, FIG. 7, 70% is calculated for a convenience store, 20% is calculated for a supermarket, and 10% is calculated for a shop.

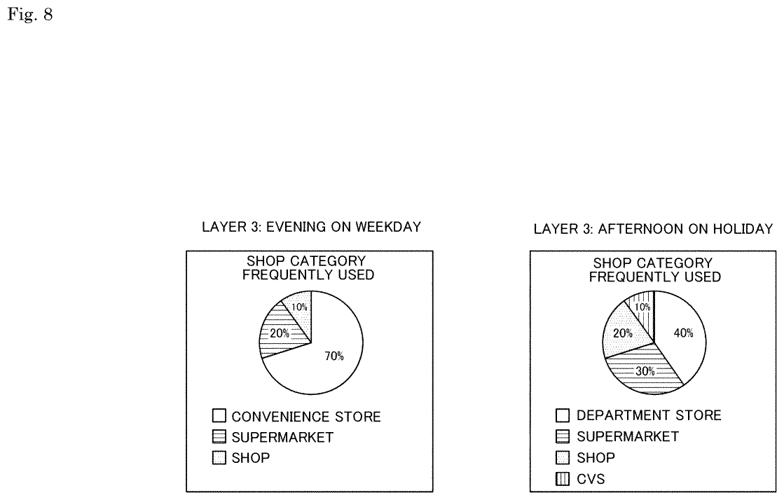

Note that a tendency of the use frequency of each shop is different depending on a time zone or a day of a week (a weekday or a holiday). The payment occasion score calculation unit 1232 may calculate the use frequency of each layer taking the time zone or the day of the week into account to enhance authentication accuracy. FIG. 8 is a diagram illustrating an example of a use frequency matching a time zone and a day of a week in a case of the layer 3 according to the present embodiment. As illustrated on the left of FIG. 8, the use frequency is, for example, 70% at the convenience store, 20% at the supermarket, and 10% at the shop in the evening on a weekday, and, as illustrated on the right of FIG. 8, the use frequency is, for example, 40% at a department store, 30% at the supermarket, 20% at the shop, and 10% at the CVS in the afternoon on a holiday.

Furthermore, the payment occasion score calculation unit 1232 calculates the payment shop score (Score_{pay_shop}) for the target shop according to the following equation. In the following equation, the use frequency of each layer is Score_{shop_category}. Furthermore, each term may be multiplied with a weight (W_{layer}) associated with each layer.

$${Score}_{pay \_ shop} = {W}_{layer 1} * {Score}_{shop \_ category 1} + {W}_{l a yer 2} * {Score}_{shop \_ category 2} + {W}_{l a yer 3} * {Score}_{shop \_ category 3} \qquad [ Math . 3 ]$$

A calculation example of a payment shop score of the shop P of the CVS A at which the user has performed payment will be described below as an example. Here, FIG. 5 is referred to as for the use frequency of the layer 1, FIG. 6 is referred to as for the use frequency of the layer 2, and FIG. 8 is referred to as for the use frequency of the layer 3. Since different use frequencies of the layer 3 are used between the evening on a weekday and the afternoon on a holiday, calculation of the payment shop score in a case of the evening on the weekday and calculation of the payment shop score in a case of the afternoon on the holiday will be exemplified. Furthermore, weights to be associated with layers are, for example, W_{layer1}: 0.2, W_{layer2}: 0.3, and W_{layer3}: 0.5.

Calculation Example of Payment Shop Score of Shop P of CVS A

$$Evening on weekday … {Score}_{pay \_ shop} = 0.2 * 0.6 + 0.3 * 0.8 + 0.5 * 0.7 = 0 \text{.71}$$

$$Afternoon on holiday … {Score}_{pay \_ shop} = 0.2 * 0.6 + 0.3 * 0.8 + 0.5 * 0.1 = 0.41$$

On the other hand, for an affiliated shop that is a shop that is not usually used and is affiliated with a shop that is usually used, it is possible to calculate a payment shop score using the layer 2 and the layer 3. The calculation example will be described below.

Calculation Example of Payment Shop Score of Affiliated Shop of CVS A

$$Evening on weekday … {Score}_{pay \_ shop} = 0.3 * 0.8 + 0.5 * 0.7 = 0 \text{.59}$$

$$Afternoon on holiday … {Score}_{pay \_ shop} = 0.3 * 0.8 + 0.5 * 0.1 = 0.29$$

Next, a calculation example of the payment device score (Score_{pay_device}) will be described. The payment device score is a score of a device used in a scene of payment. The device used for payment includes a smartphone, a smartwatch, a smart band, and the like. One user may use only one device, or may use a plurality of devices. The payment occasion score calculation unit 1232 can calculate for a target shop the payment device score per device using a use rate of each device for payment. The use rate of each device for payment can be acquired from the above payment model (including a feature amount of the payment device). The use rate of each device for payment is calculated per shop as shown in, for example, following tables 1 and 2. Furthermore, the payment occasion score calculation unit 1232 may calculate the use rate per above-described shop layer. Consequently, taking into account authentication in an area that the user has never visited, too, it is possible to give a score from a viewpoint of an affiliated shop or a shop category that is highly likely to be used by the user.

TABLE 1

| | | Smartphone | Smartwatch | Others |
|---|---|---|---|---|
| Layer 1 | CVS A Shop P | 0.72 | 0.18 | 0.10 |
| Layer 2 | CVS A | 0.74 | 0.20 | 0.06 |
| Layer 3 | CVS | 0.81 | 0.14 | 0.05 |

TABLE 2

| | | Smartphone | Smartwatch | Others |
|---|---|---|---|---|
| Layer 1 | CVS A Shop L | 1.0 | 0 | 0 |
| Layer 2 | CVS A | 0.85 | 0.15 | 0 |
| Layer 3 | CVS | 0.50 | 0.25 | 0.25 |

Note that, as described above, the use target is not limited to a shop, and payment at a public transport is also assumed, and a use rate of a payment device at a public transport is also cited as shown in, for example, following table 3.

TABLE 3

| | | Smartphone | Smartwatch | Others |
|---|---|---|---|---|
| Layer 1 | Railway A Station E | 0.2 | 0.8 | 0 |
| Layer 2 | Railway A | 0.2 | 0.8 | 0 |
| Layer 3 | Railway | 0.3 | 0.3 | 0.4 |

Furthermore, the payment occasion score calculation unit 1232 calculates the payment device score (Score_{pay_device}) for the target shop using the above-described use rate (Score_{device}) as expressed in, for example, the following equation.

$${Score}_{pay \_ device} = {W}_{devi c e} * {Score}_{d e v i c e} \qquad [ Math . 4 ]$$

A calculation example of the payment device score will be described below. The payment device score is calculated for each target shop per device. Furthermore, here, W_{devise}=1.0 holds, and a use rate of a device is a payment device score. Calculation Example of Payment Device Score Payment of Shop P of CVS A

$$Smartphone … {Score}_{pay \_ device} = 1. * 0.72 = 0 \text{.72}$$

$$Smartwatch … {Score}_{pay \_ device} = 1. * 0.18 = 0.18$$

Calculation Example of Payment Device Score Payment of Affiliated Shop of CVS A

$$Smartphone … {Score}_{pay \_ device} = 1. * 0. 74 = 0 \text{.74}$$

$$Smartwatch … {Score}_{pay \_ device} = 1. * 0. 20 = 0.20$$

Next, the payment occasion score calculation unit 1232 may calculate for the target shop the payment occasion score (Score_{payment}) by adding the payment shop score (Score_{pay_shop}) and the payment device score (Score_{pay_device}). Furthermore, the payment shop score and the payment occasion score are multiplied with weights (W_{pay_shop} and W_{pay_devise}), respectively. A calculation formula of the payment occasion score is expressed below.

$${Score}_{p a y m e n t} = {W}_{pay \_ shop} * {Score}_{pay \_ shop} + {W}_{pay \_ device} * {Score}_{pay \_ device} \qquad ( Equation )$$

Furthermore, the calculation example of the payment occasion score will be described below. The payment occasion score is calculated for each target shop per device. Here, W_{pay_shop}=0.5 and W_{pay_devise}=0.5 hold.

Calculation Example of Payment Occasion Score of Shop P of CVS A (Evening on Weekday)

$$Smartphone … {Score}_{p a y m e n t} = 0.5 * 0. 71 + 0.5 * 0. 72 = 0 \text{.715}$$

$$Smartwatch … {Score}_{p a y m e n t} = 0.5 * 0. 71 + 0.5 * 0. 18 = 0.445$$

Calculation Example of Payment Occasion Score of Affiliated Shop of CVS A (Evening on Weekday)

$$Smartphone … {Score}_{p a y m e n t} = 0.5 * 0. 59 + 0.5 * 0. 74 = 0.665$$

$$Smartwatch … {Score}_{p a y m e n t} = 0.5 * 0. 59 + 0.5 * 0. 20 = 0.395$$

### Calculation of Authentication Score

Furthermore, the authentication score calculation unit 1233 illustrated in FIG. 3 calculates for the target shop an authentication score (AuthScore) by adding a habitual score (Score_{habit}) and a payment occasion score (Score_{payment}). A calculation formula of an authentication score is expressed below. Note that each score to be added may be weighted as appropriate.

$$AuthScore = {W}_{h a b i t} * {Score}_{h a b i t} + {W}_{p a y n ι e n t} * {Score}_{p a y m e n t} \qquad [ Math . 5 ]$$

A calculation example of an authentication score will be described below. The authentication score is calculated for each target shop per device. Here, W_{habit}=0.6 and W_{payment}=0.4 hold. Furthermore, the evening on a certain weekday is assumed, and a case of habitual score (Score_{habit})=0.88 is assumed.

Calculation Example of Payment Occasion Score of Shop P of CVS A (Evening on Weekday)

$$Smartphone … Auth Score = 0.6 * 0.88 + 0.4 * 0.715 = 0 \text{.814}$$

$$Smartwatch … Auth Score = 0.6 * 0. 88 + 0.4 * 0. 445 = 0.706$$

Calculation Example of Payment Occasion Score of Affiliated Shop of CVS A (Evening on Weekday)

$$Smartphone … Auth Score = 0.6 * 0.88 + 0.4 * 0. 665 = 0 \text{.794}$$

$$Smartwatch … Auth Score = 0.6 * 0. 88 + 0.4 * 0. 395 = 0.686$$

A method for calculating each score described above is an example, and the present embodiment is not limited thereto. Furthermore, each calculated score is stored in a score DB 165.

Next, back to FIG. 1, the authentication success/failure determination unit 124 will be described. The authentication success/failure determination unit 124 determines whether authentication succeeds or fails based on the authentication score calculated by the score calculation unit 123. More specifically, the authentication success/failure determination unit 124 determines that authentication succeeds when the authentication score calculated for a target shop exceeds an authentication threshold. By displaying whether authentication at a shop around a current position of the user on, for example, a map succeeds or fails in other than a scene that actual authentication (more specifically, identity verification for permitting payment) is performed, the user can intuitively recognize a shop at which payment can be performed.

The display control unit 125 performs control of displaying various operation screens, a display screen that displays an authentication success/failure determination result of each shop, and the like on the display unit 150.

The payment control unit 126 performs control related to payment. More specifically, the payment control unit 126 performs authentication processing based on the authentication score at the target shop calculated by the score calculation unit 123, and permits payment at the target shop when authentication succeeds (when the authentication score exceeds the authentication threshold). The target shop may be determined based on the position information of the user, and a signal (such as a payment request signal) received from a settlement device of the store. Payment processing may be performed by the payment control unit 126, or may be performed another wearable device (such as a smartwatch and a smart band). When, for example, permitting the payment, the payment control unit 126 can perform control of transmitting information that is necessary for the payment processing from the communication unit 110 to the settlement device of the shop or the like. Note that specific processing related to payment is not limited here.

### (Storage Unit 160)

The storage unit 160 is implemented by a Read Only Memory (ROM) that stores programs, arithmetic operation parameters, or the like used for processing of the control unit 120, and a Random Access Memory (RAM) that temporarily stores appropriately changing parameters, or the like.

For example, the storage unit 160 stores the activity history Data Base (DB) 161, a payment history DB 162, an activity habitual model DB 163, a payment model DB 164, and a score DB 165. The activity history DB 161 stores an activity history of the user collected by the data collection unit 121. The payment history DB 162 stores a payment history of the user collected by the data collection unit 121. The activity habitual model DB 163 stores an activity habitual model generated by the model generation unit 122. The payment model DB 164 stores a payment model generated by the model generation unit 122. The score DB 165 stores various scores calculated by the score calculation unit 123. Furthermore, the score DB 165 may store various parameters (such as weight data and a threshold) that are necessary to calculate the scores.

Although the configuration of the information processing device 10 has been specifically described above, the configuration of the information processing device 10 according to the present disclosure is not limited to the example illustrated in FIG. 1. For example, the information processing device 10 may employ a configuration that does not include the operation input unit 130 and the display unit 150. Furthermore, the information processing device 10 may be implemented by a plurality of devices. Furthermore, at least part of the functions of the information processing device 10 may be implemented by a server.

### <<3. Operation Processing>>

Next, operation processes according to the present embodiment will be more specifically described with reference to the drawings.

### <3-1. Authentication Score Calculation Processing>

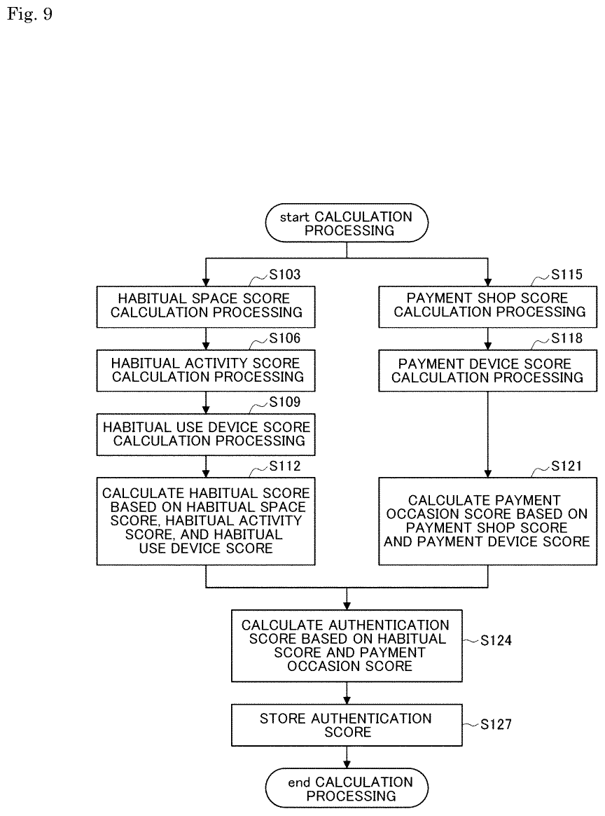

FIG. 9 is a flowchart illustrating an example of a flow of authentication score calculation processing according to the present embodiment. As illustrated in FIG. 9, first, the habitual score calculation unit 1231 calculates a habitual space score (step S103), calculates a habitual activity score (step S106), and calculates a habitual use device score (step S109) for a target shop, and calculates a habitual score based on these scores (step S112).

Furthermore, the payment occasion score calculation unit 1232 calculates a payment shop score (step S115) and calculates a payment device score (step S118) for the target shop, and calculates a payment occasion score based on these scores (step S121).

Next, the authentication score calculation unit 1233 calculates the authentication score of the target shop based on the habitual score and the payment occasion score (step S124).

Next, the score calculation unit 123 stores the calculated authentication score in the score DB 165 (step S127). Storage in the score DB 165 may be updated when the authentication score of the target shop is newly calculated. Furthermore, the calculated authentication score may be output to the authentication success/failure determination unit 124, the display control unit 125, and the payment control unit 126. Furthermore, this operation is finished.

The above-described calculation of the authentication score is performed per target shop. The target shop corresponds to a shop at which payment is performed in a payment scene. Furthermore, the shop corresponds to a shop (e.g., a shop located within a certain range from the user) displayed on a map in a scene that displays an authentication success/failure determination result on a map image.

### <3-2. Payment Processing>

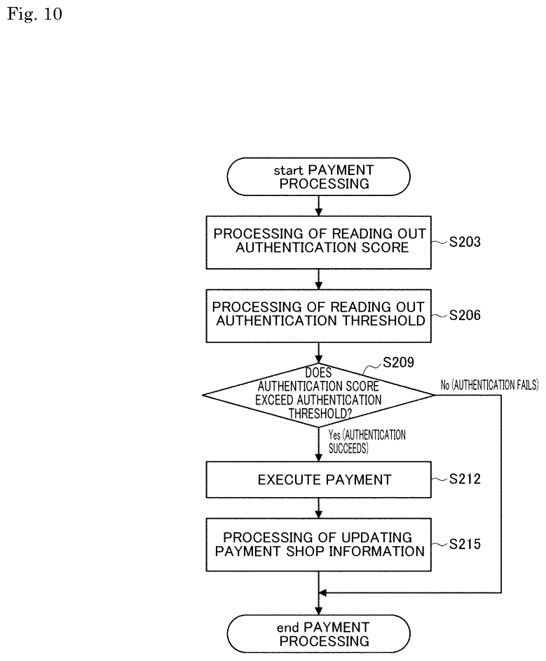

FIG. 10 is a flowchart illustrating an example of a flow of payment processing according to the present embodiment. As illustrated in FIG. 10, first, the payment control unit 126 reads out an authentication score of a target shop (a shop at which payment is about to be performed) from the score DB 165 (step S203).

Next, the payment control unit 126 reads out an authentication threshold from the score DB 165 (step S206).

Next, the payment control unit 126 determines whether or not the authentication score exceeds the authentication threshold (step S209).

Next, when the authentication score exceeds the authentication threshold (step S209/Yes), the payment control unit 126 determines that authentication succeeds, and permits payment (step S212). The payment control unit 126 executes payment processing (e.g., payment processing matching a payment request from a settlement device of a store) as needed.

Next, the payment control unit 126 updates payment shop information when payment is finished (step S215). More specifically, the payment control unit 126 accumulates information on the payment store as a payment history in the payment history DB 162.

On the other hand, when the authentication score does not exceed the authentication threshold (step S209/No), the payment control unit 126 determines that authentication fails, does not permit payment, and finishes the operation of the payment processing.

### <3-3. Display Processing>

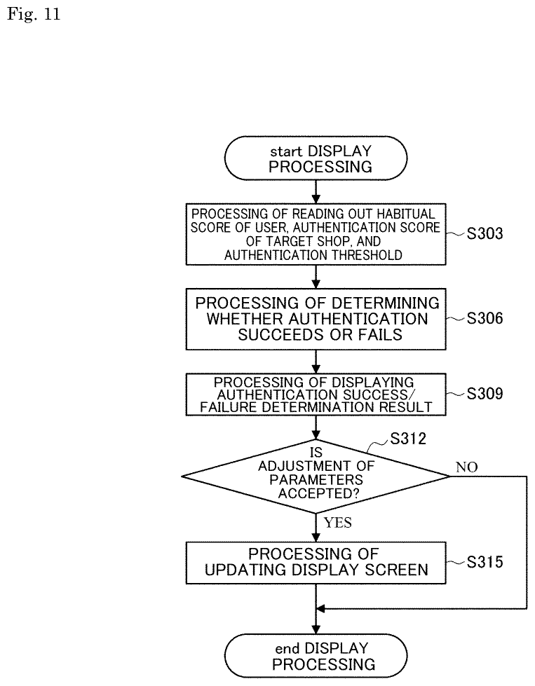

FIG. 11 is a flowchart illustrating an example of a flow of authentication success/failure decision display processing according to the present embodiment. As illustrated in FIG. 11, first, the authentication success/failure determination unit 124 reads out the habitual score of the user, the authentication score of the target shop, and the authentication threshold from the score DB 165 (step S303). The target shop is, for example, a shop located within a certain range from a current position of the user or within a range displayed on a map.

Next, the authentication success/failure determination unit 124 determines whether authentication succeeds or fails, for the target shop based on the authentication score of the target shop and the authentication threshold (step S306).

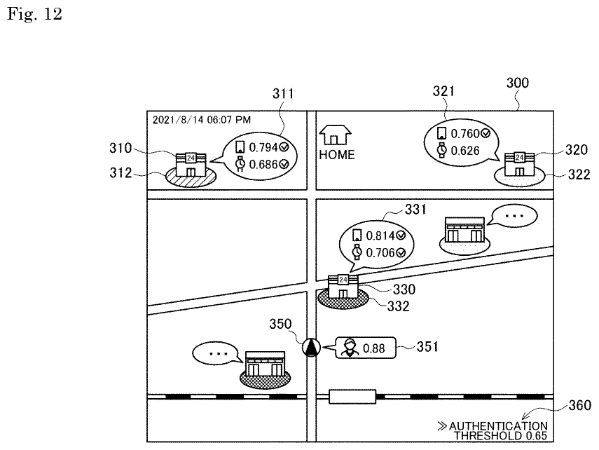

Next, the display control unit 125 performs processing of displaying on the map image an authentication success/failure determination result of each target shop (step 309). The authentication success/failure determination result of each target shop may be displayed per payment device. Shops for which success of authentication has been determined, that is, at which hands-free payment and touch payment can be performed are explicitly displayed. Here, a display screen example of an authentication success/failure determination result according to the present embodiment will be described with reference to FIG. 12.

FIG. 12 is a diagram illustrating an example of a display screen showing an authentication success/failure determination result according to the present embodiment. As illustrated in FIG. 12, a display screen 300 displays shop icons (e.g., a shop icon 310, a shop icon 320, and a shop icon 330), authentication scores of each shop (e.g., a score indication 311, a score indication 321, and a score indication 331), a mark 350 that indicates the current position of the user, a habitual score indication 351 of the user, and an authentication threshold indication 360 on the map image. Each shop icon may be an icon that indicates a difference of at least a shop category (a business category of a CVS, a supermarket, a department store, and the like), or may be an icon that indicates which business affiliation (company) a shop is affiliated with.

The score indications of each shop are displayed together with check marks indicating that payment can be performed on a device at which, for example, hands-free payment can be performed (i.e., a device whose authentication score of each device exceeds the authentication threshold). Consequently, the user can intuitively recognize the shops and the device at which, for example, hands-free payment can be performed. Note that, although both of smartphones and smartwatches are taken into account as payment devices in the example illustrated in FIG. 12, the present embodiment is not limited thereto, and only an authentication score of a smartphone may be displayed as the score indication of each shop when, for example, the user uses only the smartphone.

Furthermore, according to the present embodiment, the authentication threshold is displayed on the display screen 300, so that the user can recognize to what degree the authentication score is insufficient for shops and payment devices (without check marks) at which payment cannot be performed. Furthermore, a habitual score based on a user's activity is displayed on the display screen 300, so that the user can recognize scores of the own activity.

Furthermore, the display screen 300 may display layer indications (e.g., a layer indication 312, a layer indication 322, and a layer indication 332) explicitly indicating whether a shop is a shop used by the user, a shop that has never been used yet is affiliated with the shop used by the user, or a shop that has never been used yet is in the same category as that of the shop used by the user. The layer indications may be an image of a different color, pattern, and density per layer. In the example illustrated in FIG. 12, the layer indication 332 indicates a shop used by the user, the layer indication 312 indicates a shop that has never been used yet is affiliated with the shop used by the user, and the layer indication 322 indicates a shop that has never been used yet is in the same category as that of the shop used by the user. Although the example illustrated in FIG. 12 indicates that the authentication score of the smartwatch does not reach the authentication threshold and payment cannot be performed at a shop of the shop icon 320, the user can recognize that the shop indicated by the shop icon 320 is a shop that is not usually used and at which authentication of the smartwatch that is not used much in particular does not succeed by visually recognizing the layer indication 322 displayed as a background image of the shop icon 320.

Here, while, as described above, the authentication score is calculated from the habitual score based on the user's activity and the payment occasion score based on the payment history of the user, when the user's activity greatly changes from an everyday activity due to moving, job change (change of a working place), business trip, or travel, the habitual score lowers, and the authentication score also lowers accompanying the habitual score. According to the present embodiment, although, by using the payment occasion score, too, for the authentication score, it is possible to secure an identity based on the payment occasion score to some degree even in a situation that the habitual score lowers more or less, the identity can be also secured as long as the authentication score does not exceed the authentication threshold, and, when the habitual score significantly lowers and the authentication score does not exceed the authentication threshold, hands-free payment or the like cannot be performed. By contrast with this, according to the present embodiment, by adjusting parameters used for calculation of the authentication score or authentication by some methods as appropriate, it is possible to enhance user-friendliness of authentication.

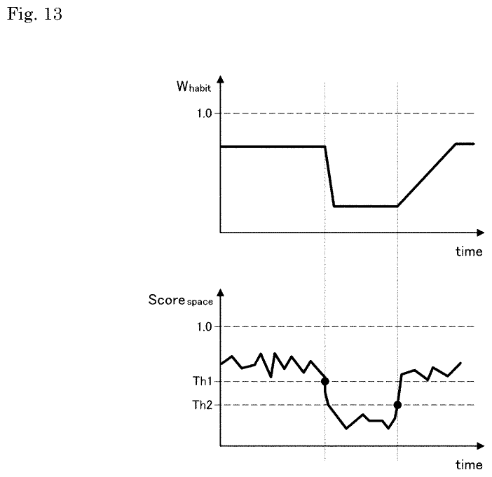

First, one of methods includes that the score calculation unit 123 performs processing of relatively increasing a weight (W_{payment}) used for calculation of the payment occasion score compared to a weight (W_{habit}) to be multiplied on the habitual score. The score calculation unit 123 may decrease W_{habit}, or increase W_{payment}. By relatively increasing the weight of the payment occasion score, it is possible to make it easy to use a shop that is highly likely to be used by the user itself such as a shop that is affiliated with or in the same category as that of a shop usually used by the user. Hereinafter, specific description will be given with reference to FIG. 13.

FIG. 13 is a diagram for explaining an example of weight adjustment according to the present embodiment. In the control unit 120, when, for example, a habitual space score (Score_{space}) calculated based on position information among the scores used for calculation of the habitual score goes below a first threshold (Th1) as illustrated in FIG. 13, the score calculation unit 123 may decrease the weight (W_{habit}) to a predetermined lower limit value, and, when the habitual space score (Score_{space}) exceeds a second threshold (Th2), the score calculation unit 123 may increase the weight (W_{habit}) to a predetermined upper limit value. Note that W_{payment}=(1−W_{habit}) holds, and 0≤W and Score≤1 hold.

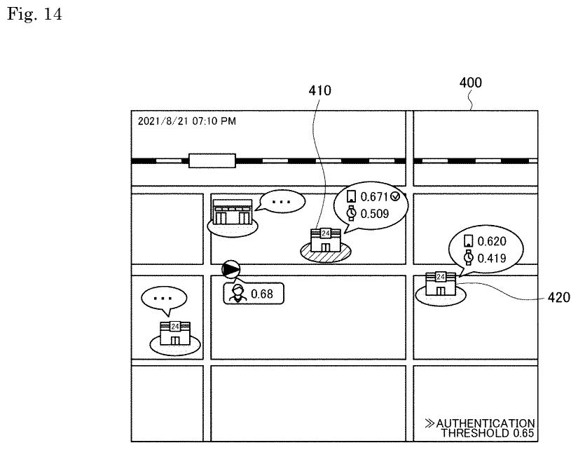

FIG. 14 is a diagram illustrating an example of the display screen showing an authentication determination result based on the authentication score corrected by weight adjustment according to the present embodiment. As illustrated in FIG. 14, when, for example, the user visits a place that is not usually used due to business trip or travel, the habitual score (Score_{habit}) calculated based on the user's activity lowers to 0.68. Note that, such a habitual score is an example, yet decreases compared to habitual score (Score_{habit})=0.88 (of the place that is usually used) in the case described with reference to FIG. 12. In this case, the score calculation unit 123 relatively increases the weight W_{payment} to be multiplied on the payment occasion score compared to the weight W_{habit} to be multiplied on the habitual score, and calculates an authentication score of a target shop. A calculation example of an authentication score (Auth Score) will be described below. Here, W_{habit}=0.4 and W_{payment}=0.6 hold.

Calculation Example of Payment Occasion Score of Affiliated Shop of CVS A (Evening on Weekday)

$$Smartphone … Auth Score = 0.4 * 068 + 0.6 * 0. 665 = 0 \text{.671}$$

$$Smartwatch … Auth Score = 0.4 * 0. 68 + 0.6 * 0. 395 = 0.509$$

Consequently, as illustrated in FIG. 14, an authentication score is “0.671” at a time of use of a smartphone at, for example, a target shop 410 (an affiliated shop of the CVS A), and hands-free payment can be performed even at an affiliated shop of a shop used by the user (here, an affiliated shop of the CVS A) even at a place that is not usually used.

The above weight adjustment can be automatically performed by the control unit 120. On the other hand, it is also possible to display a User Interface (UI) used by the user to arbitrarily adjust the weight, and accept a user input and adjust various parameters used for the authentication score. In the example illustrated in, for example, FIG. 14, payment cannot be performed using a smartwatch at the target shop 410, and payment cannot be performed using any payment device at a target shop 420. Authentication may be performed by displaying a predetermined UI, and making the user arbitrarily adjust parameters.

Back to FIG. 11, processing in a case where the parameters are adjusted will be described. When accepting an input of parameter adjustment by the user from a displayed adjustment screen as appropriate (step S312/Yes), the control unit 120 performs display screen update processing of recalculating the authentication score, determining whether authentication succeeds or fails, and displaying a new authentication success/failure determination result (step S315).

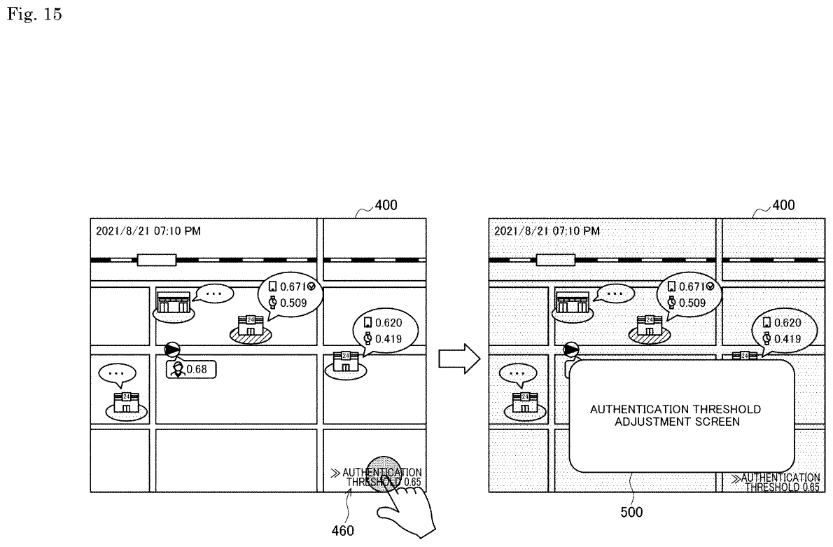

Hereinafter, parameter adjustment according to the present embodiment will be described below with reference to FIGS. 15 to 21.

### (Parameter Adjustment)

Examples of parameter adjustment according to the present embodiment include adjustment of various numerical values (e.g., weights) used at a time of calculation of an authentication score, and adjustment of an authentication threshold used at a time of determination on whether authentication succeeds or fails (similar to the authentication threshold used for authentication processing at a time of payment).

### Adjustment of Authentication Threshold

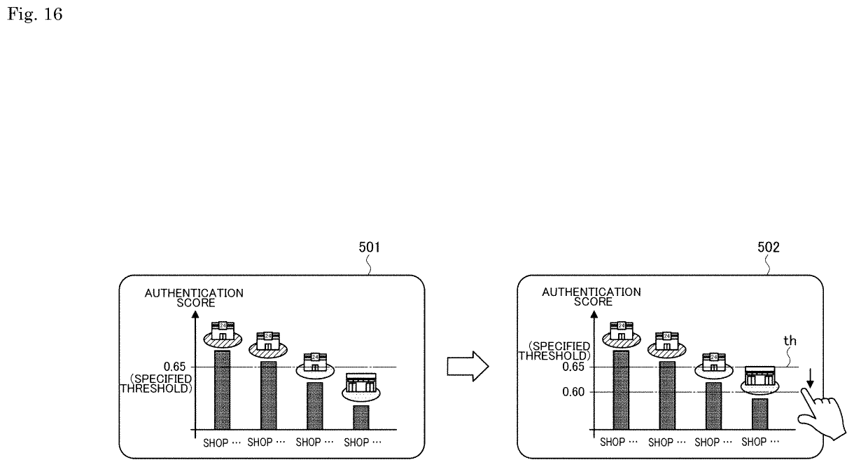

FIG. 15 is a diagram for explaining adjustment of an authentication threshold according to the present embodiment. As illustrated on the left of FIG. 15, when, for example, a user taps (such as double-taps or presses long) an authentication threshold indication 460 displayed on a display screen 400. As illustrated on the right of FIG. 15, an adjustment screen 500 of an authentication threshold is superimposed and displayed. A specific example of the adjustment screen 500 of the authentication threshold will be described with reference to FIG. 16.

FIG. 16 is a diagram illustrating an example of the adjustment screen of the authentication threshold according to the present embodiment. As illustrated on the left in FIG. 16, first an adjustment screen 501 displays authentication scores of shops as graphs, and, moreover, a specified authentication threshold (e.g., 0.65) is indicated for these graph indications. The specified authentication threshold may be set in advance to such a degree that, for example, authentication at a shop whose use rate of the user is higher succeeds. By sliding the authentication threshold (th) as shown on an adjustment screen 502 on the right of FIG. 16, the user can intuitively change the authentication threshold to an arbitrary authentication threshold (e.g., 0.60). Note that, although the control unit 120 can also simultaneously display authentication scores of both of a smartphone and a smartwatch, this display becomes complicated, and therefore, for example, checkboxes of payment devices may be provided, and a payment device may be narrowed down to a payment device with the checked checkbox and displayed. The authentication success/failure determination unit 124 determines whether authentication at each target shop succeeds or fails based on the changed authentication threshold. The display control unit 125 updates the display screen of the authentication success/failure determination result based on a new authentication success/failure determination result.

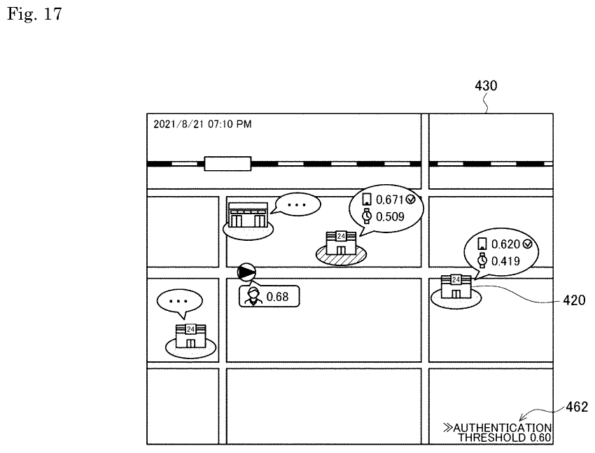

FIG. 17 is a diagram illustrating an example of the display screen updated by adjusting the authentication threshold according to the present embodiment. As illustrated in FIG. 17, an authentication threshold indication 462 indicating a value (e.g., 0.60) of the adjusted authentication threshold is displayed on a display screen 430, and check marks indicating that payment is possible are displayed on a side of the authentication scores that exceed the authentication threshold. As illustrated in FIG. 17, it is possible to newly perform payment using the smartphone at the target shop 420 by adjusting the authentication threshold.

### Weight Adjustment of Store Layer

An example of parameter adjustment includes adjustment of various parameters used for calculation of the payment occasion score. By adjusting calculation of the payment occasion score, it is possible to keep a balance between security of authentication for payment and user-friendliness without influencing the habitual score and lowering authentication accuracy for other uses that use the habitual score.

For example, the control unit 120 accepts weight adjustment of a shop layer used for calculation of the payment shop score. By adjusting the weight of the shop layer, it is possible to adjust a score of a shop (layer 1) used by the user, a score of an affiliated shop (layer 2) used by the user, and a score of a shop category (layer 3) used by the user as appropriate.

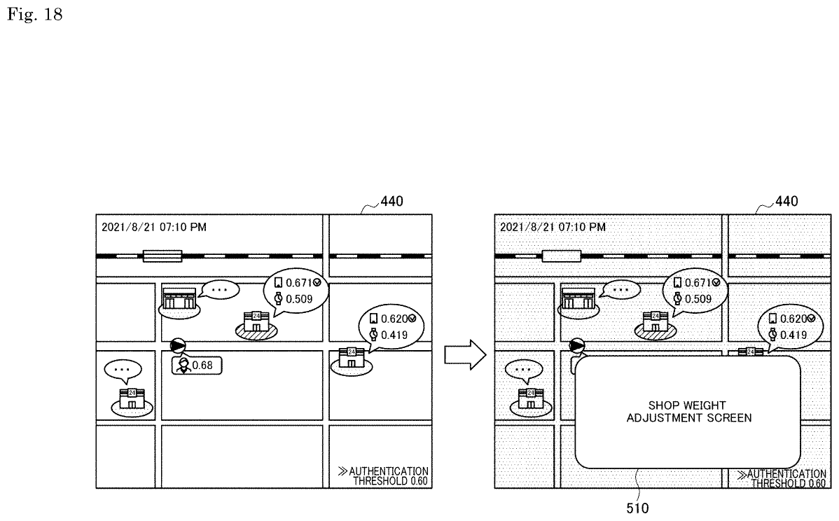

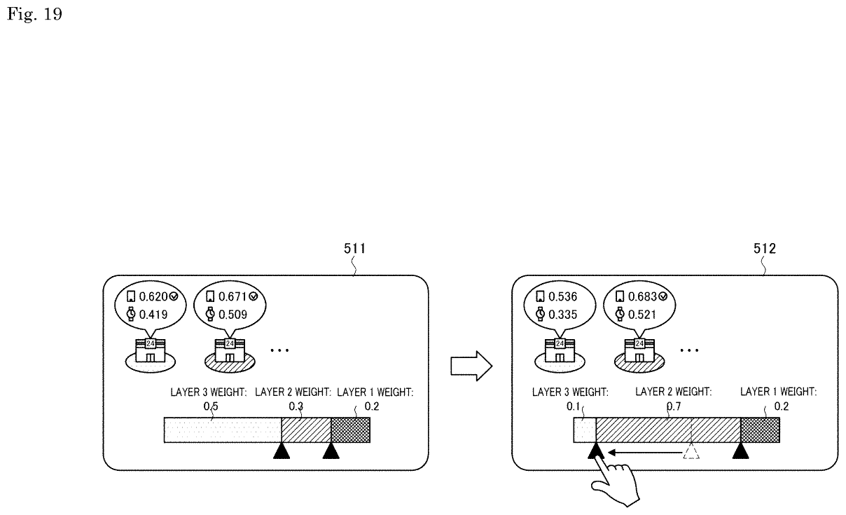

FIG. 18 is a diagram for explaining weight adjustment of the shop layer according to the present embodiment. A case will be described in the example illustrated in FIG. 18 where, when the authentication threshold is made lower than the specified threshold for user-friendliness when the above-described authentication threshold is adjusted, the payment occasion score is adjusted to keep the balance between the user-friendliness and authentication security. As illustrated on the left of FIG. 18, when, for example, the user taps (such as double-taps or presses long) one of target shop icons (or layer indications) displayed on a display screen 440, a weight adjustment screen 510 of a shop layer is superimposed and displayed as illustrated on the right of FIG. 18. A specific example of the weight adjustment screen 510 of the shop layer will be described with reference to FIG. 19.

FIG. 19 is a diagram illustrating an example of the weight adjustment screen of the shop layer according to the present embodiment. As illustrated on the left of FIG. 19, first, an adjustment screen 511 displays a bar indication indicating weights of shop layers, and each shop icon and each authentication score displayed on a map. By sliding and moving an adjustment lever of the bar as displayed on an adjustment screen 512 on the right of FIG. 19, the user can intuitively change the weight of each layer. In the example illustrated in FIG. 19, by decreasing the ratio of the weight of the layer 3 (shop category), and increasing the ratio of the weight of the layer 2 (affiliated shop), it is possible to increase the authentication score of the shop of the layer 2 and decrease the authentication score of the shop of the layer 3. The authentication success/failure determination unit 124 recalculates the authentication score of each target shop based on the weight of the changed shop layer. Next, the authentication success/failure determination unit 124 determines again whether authentication succeeds or fails based on the recalculated authentication score. In the example illustrated in FIG. 19, check marks indicating whether or not payment at a target shop can be performed (whether or not authentication succeeds) are displayed in real time according to weight adjustment of the shop layer. Here, by decreasing the weight of the layer 3, it is possible to decrease the authentication score of the shop of the layer 3, and keep the balance between the decreased authentication threshold and the authentication security.

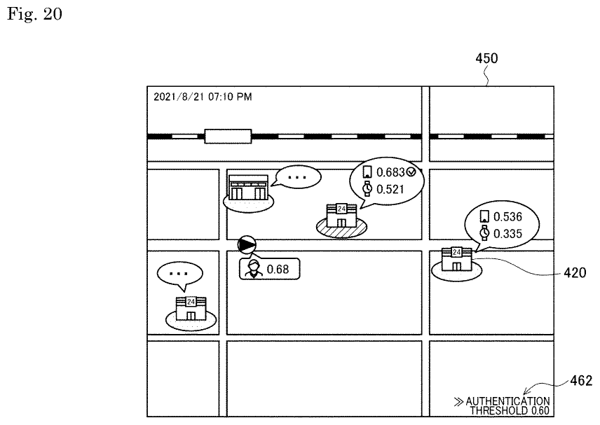

Furthermore, the display control unit 125 updates the display screen of the authentication success/failure determination result based on a new authentication success/failure determination result. FIG. 20 is a diagram illustrating an example of the display screen updated by weight adjustment of the shop layer according to the present embodiment. In the display screen 450 illustrated in FIG. 20, the authentication score of the shop (target shop 420) of the layer 3 is decreased by adjustment, and a check mark is removed. Here, although the example has been described where the ratio of the weight of the layer 3 is decreased to keep the balance between the decreased authentication threshold and the authentication security, the present embodiment is not limited thereto, and adjustment may be performed to temporarily increase the weight of the layer 3 when, for example, the user needs to use the shop of the layer 3. As described above, when the habitual score lowers at a different place from that of an everyday life, it is possible to maintain user-friendliness of authentication by enabling the user to arbitrarily adjust parameters.

The example of the parameter adjustment according to the present embodiment has been described above. Note that the control unit 120 may display a screen for adjustment of relatively increasing the weight (W_{payment}) used for calculation of the payment occasion score compared to the weight (W_{habit}) to be multiplied on the above-described habitual score to enable the user to arbitrarily adjust the parameters.

### <<4. Supplements>>

Although the preferred embodiment of the present disclosure has been described in detail with reference to the accompanying drawings, the present disclosure is not limited to such examples. It is obvious that one with ordinary knowledge in the technical field of the present disclosure may conceive various modification examples or change examples within the scope of the technical ideas set forth in the claims and, of course, it is understood that these belong to the technical scope of the present disclosure.

Furthermore, one or more computer programs for performing the functions of the information processing device 10 can be also created in hardware such as a CPU, a ROM, and a RAM built in the above-described information processing device 10. Furthermore, a computer-readable storage medium having the one or more computer programs stored therein is also provided.

Further, the effects described in the present specification are merely explanatory or exemplary and are not intended as limiting. That is, the techniques according to the present disclosure may exhibit other effects apparent to those skilled in the art from the description herein, in addition to or in place of the above effects.

The present technology can also be configured as follows.

(1)

An information processing device includes a control unit that performs: processing of calculating a target authentication score based on a habitual score calculated based on an activity of a user and habitual information of the user, and a use occasion score calculated based on a target use history of the user; and processing of determining based on the target authentication score whether authentication at a target succeeds or fails.

(2)

The information processing device according to above (1), wherein, the control unit changes a threshold used for the determination on whether or not the authentication succeeds according to a user input.

(3)

The information processing device according to above (1) or (2), wherein the control unit changes a parameter used for the calculation of the use occasion score according to a user input.

(4)

The information processing device according to any one of above (1) to (3), wherein, the control unit performs processing of displaying on a map image a determination result on whether authentication at each target succeeds or fails.

(5)

The information processing device according to above (4), wherein, the control unit performs processing of further displaying a target authentication score calculated per target and a threshold used for the determination on whether the authentication succeeds or fails.

(6)

The information processing device according to above (4) or (5), wherein, the control unit performs processing of further displaying the habitual score calculated based on a current activity of the user and the habitual information.

(7)

The information processing device according to any one of above (4) to (6), wherein, the control unit performs processing of explicitly indicating which layer of target layers each target indicated on the map image belongs.

(8)

The information processing device according to any one of above (4) to (7), wherein, the control unit performs processing of displaying a screen for accepting adjustment of the user for the threshold used for the determination on whether the authentication succeeds or fails.

(9)

The information processing device according to any one of above (4) to (8), wherein, the control unit performs processing of displaying a screen for accepting adjustment of the user for the parameter used for the calculation of the use occasion score.

(10)

The information processing device according to above (9), wherein
a target score based on the target use history is used for the calculation of the use occasion score, and
the parameter is a weight to be used for calculation of the target score and set to a target layer.
   (11)

The information processing device according to above (9), wherein, the parameter is a weight to be multiplied on the use occasion score for calculation of the authentication score.

(12)

The information processing device according to any one of above (4) to (11), wherein
the target use history includes information on a target used by the user and information on a device used for payment of the target,
a target score and a device score calculated based on the target use history are used for the calculation of the use occasion score, and
the control unit performs processing of
calculating for each target the use occasion score per device,
determining whether authentication at the target succeeds or fails based on the calculated use occasion score per device and the habitual score, and
displaying on the map image for each target the determination result on whether authentication per device succeeds or fails.
   (13)

The information processing device according to any one of above (1) to (12), wherein, the target use history includes information related to a shop at which the user has performed payment.

(14)

The information processing device according to any one of above (4) to (13), wherein, whether authentication at the target succeeds or fails is whether authentication used for performing payment at a shop succeeds or fails.

(15)

The information processing device according to any one of above (1) to (13), wherein, the control unit performs processing of relatively increasing a weight to be multiplied on the use occasion score compared to a weight to be multiplied on the habitual score to calculate the authentication score when the habitual score goes below a threshold.

(16)

An information processing method includes at a processor:
calculating a target authentication score based on a habitual score calculated based on an activity of a user and habitual information of the user, and a use occasion score calculated based on a target use history of the user; and
determining based on the target authentication score whether authentication at a target succeeds or fails.
   (17)

A program causing a computer to function as
a control unit that performs:
processing of calculating a target authentication score based on a habitual score calculated based on an activity of a user and habitual information of the user, and a use occasion score calculated based on a target use history of the user; and processing of determining based on the target authentication score whether authentication at a target succeeds or fails.

### REFERENCE SIGNS LIST

10 Information processing device
110 Communication unit
120 Control unit
121 Data collection unit
122 Model generation unit
123 Score calculation unit
124 Authentication success/failure determination unit
125 Display control unit
126 Payment control unit
130 Operation input unit
140 Sensor
150 Display unit
160 Storage unit
161 Activity history DB
162 Payment history DB
163 Activity habitual model DB
164 Payment model DB
165 Score DB

1. An information processing device comprising a control unit that performs:
processing of calculating a target authentication score based on a habitual score calculated based on an activity of a user and habitual information of the user, and a use occasion score calculated based on a target use history of the user; and
processing of determining based on the target authentication score whether authentication at a target succeeds or fails.

2. The information processing device according to claim 1, wherein the control unit changes a threshold used for the determination on whether the authentication succeeds or fails according to a user input.

3. The information processing device according to claim 1, wherein the control unit changes a parameter used for the calculation of the use occasion score according to a user input.

4. The information processing device according to claim 1, wherein the control unit performs processing of displaying on a map image a determination result on whether authentication at each target succeeds or fails.

5. The information processing device according to claim 4, wherein the control unit performs processing of further displaying a target authentication score calculated per target, and a threshold used for the determination on whether the authentication succeeds or fails.

6. The information processing device according to claim 4, wherein the control unit performs processing of further displaying the habitual score calculated based on a current activity of the user and the habitual information.

7. The information processing device according to claim 4, wherein the control unit performs processing of explicitly indicating which layer of target layers each target indicated on the map image belongs.

8. The information processing device according to claim 4, wherein the control unit performs processing of displaying a screen for accepting adjustment of the user for the threshold used for the determination on whether the authentication succeeds or fails.

9. The information processing device according to claim 4, wherein the control unit performs processing of displaying a screen for accepting adjustment of the user for the parameter used for the calculation of the use occasion score.

10. The information processing device according to claim 9, wherein
a target score based on the target use history is used for the calculation of the use occasion score, and
the parameter is a weight to be used for calculation of the target score and set to a target layer.

11. The information processing device according to claim 9, wherein the parameter is a weight to be multiplied on the use occasion score for calculation of the authentication score.

12. The information processing device according to claim 4, wherein the target use history includes information on a target used by the user and information on a device used for payment of the target,
a target score and a device score calculated based on the target use history are used for the calculation of the use occasion score, and
the control unit performs processing of
calculating for each target the use occasion score per device,
determining whether authentication at the target succeeds or fails based on the calculated use occasion score per device and the habitual score, and
displaying on the map image for each target the determination result on whether authentication per device succeeds or fails.

13. The information processing device according to claim 1, wherein the target use history includes information related to a shop at which the user has performed payment.

14. The information processing device according to claim 4, wherein whether authentication at the target succeeds or fails is whether authentication used for performing payment at a shop succeeds or fails.

15. The information processing device according to claim 1, wherein the control unit performs processing of relatively increasing a weight to be multiplied on the use occasion score compared to a weight to be multiplied on the habitual score to calculate the authentication score when the habitual score goes below a threshold.

16. An information processing method comprising at a processor:
calculating a target authentication score based on a habitual score calculated based on an activity of a user and habitual information of the user, and a use occasion score calculated based on a target use history of the user; and
determining based on the target authentication score whether authentication at a target succeeds or fails.

17. A program causing a computer to function as a control unit that performs:
processing of calculating a target authentication score based on a habitual score calculated based on an activity of a user and habitual information of the user, and a use occasion score calculated based on a target use history of the user; and
processing of determining based on the target authentication score whether authentication at a target succeeds or fails.
